(19) United States
(12) Patent Application Publication
(10) Pub. No.: US 2012/0159993 A1
(43) Pub. Date: Jun. 28, 2012

(54) FEEDSTOCK MELTING AND CASTING SYSTEM AND PROCESS

(75) Inventors: Robert J. Geertsen, Moses Lake, WA (US); Franz Hugo, Aschaffenburg (DE)

(73) Assignee: REC Silicon Inc.

(21) Appl. No.: 13/305,599

(22) Filed: Nov. 28, 2011

Related U.S. Application Data
(60) Provisional application No. 61/417,993, filed on Nov. 30, 2010.

(51) Int. Cl. C03B 19/02

(52) U.S. Cl. 65/99.1; 65/258; 65/157

(57) ABSTRACT

Embodiments of a system and method for melting feedstock and casting ingots are disclosed. The system comprises a feedstock source, a stationary melting furnace, and one or more solidification modules capable of receiving molten feedstock from the melting furnace. In some embodiments, the system further includes a feed system for transferring feedstock from the feedstock source to the melting furnace. Feedstock is fed into the melting furnace and heated to produce molten feedstock. Molten feedstock flows into a solidification crucible within the solidification module. The solidification crucible is cooled to provide directional solidification and production of an ingot. The melting furnace may include a thermal valve system to prevent molten feedstock from flowing into the solidification crucible until substantially all of the feedstock within the melting furnace is molten. In some embodiments, the feedstock consists essentially of silicon and a multi-crystalline silicon ingot is produced.

### CROSS REFERENCE TO RELATED APPLICATION

This claims the benefit of U.S. Provisional Application No. 61/417,993, filed Nov. 30, 2010, which is incorporated herein by reference.

### FIELD

The present invention concerns systems and processes for melting a feedstock and casting an ingot.

### BACKGROUND

Fine-grain (e.g., less than 1 mm) silicon powder fractions are produced during silicon deposition during fluidized bed reactor and Siemens reactor processes, when crushing or grinding polycrystalline silicon, and/or when sawing silicon rods or blocks. Due to its fine form and relatively high contamination, this silicon powder has generally been considered a waste product or a low-value product suitable only for industrial applications such as, e.g., an additive in steel production. Due to growing demand for polysilicon from the photovoltaic industry, polysilicon is in limited supply. Thus, a need exists for a method to convert silicon powder into a more valuable product such as purified multi-crystalline silicon. Advantageously, the method would also be suitable for converting other feedstocks into more valuable products.

### SUMMARY

Embodiments of a system and method for melting a feedstock and casting ingots are disclosed. The feedstock may be a metal, a metalloid, or even a metal alloy. The feedstock may be powder, fines, granules, chunks, or any combination thereof. In some embodiments, the feedstock comprises silicon. In one embodiment, the feedstock consists essentially of silicon, and an ingot consisting essentially of silicon is produced.

Embodiments of the system include a feedstock source (e.g., a feedstock container), a stationary melting furnace, and a solidification module. In some embodiments, the system further includes a feed system to transfer feedstock from the feedstock source to the melting furnace.

In one embodiment, the feed system includes a docking system capable of detachably coupling the feedstock container to a feeder (e.g., a vibrating or pneumatic feeder), which transfers feedstock to a gravimetric feeder, a vacuum lock hopper, and a feed pipe through which the feedstock is expelled from the vacuum lock hopper into the melting furnace.

In another embodiment, the feed system includes a powder transfer suction tube, a vacuum lock hopper, a source of negative pressure, a vacuum transfer hose in fluid communication with the powder transfer suction tube and the vacuum lock hopper, and a feed pipe through which the feedstock is expelled from the vacuum lock hopper into the melting furnace.

A stationary melting furnace is coupled to the feed pipe to receive feedstock from the feed system. The melting furnace has an outer shell, one or more furnace heating elements, an insulation layer, and a furnace chamber defined by a vessel. The vessel has an upper portion with substantially vertical walls, and a lower portion wherein the inwardly facing surface of the lower portion has a generally conical configuration tapering downwardly to define an outlet through which molten feedstock can flow out of the melting furnace. In one embodiment, the vessel includes a liner and a liner support. In another embodiment, the vessel is a melting crucible. The melting furnace further includes a feed port in its upper wall to receive feedstock from the feed pipe, and a gas inlet extending through the upper wall and in fluid communication with the furnace chamber. A wall of the outer shell defines a vacuum port that is in fluid communication with the furnace chamber. The melting furnace also includes a valve assembly coupled to its lower wall. In particular arrangements, the melting furnace further includes a thermal valve system operable to maintain the vicinity of the outlet at a temperature independent of the furnace chamber temperature.

A solidification module is detachably coupled to the melting furnace. The solidification module includes an outer shell and an inner chamber defined by an insulation layer positioned within the outer shell. The inner chamber contains a solidification crucible having an upwardly opening cavity. Desirably, the solidification crucible is supported by a crucible support and a heat sink, e.g., a heat exchanger. The inner chamber further includes one or more heating elements positioned above and/or around the solidification crucible. A valve assembly is coupled to an upper wall of the solidification module to enable coupling of the solidification module to the melting furnace's valve assembly. The two valve assemblies in combination comprise a docking assembly. In one embodiment, the solidification crucible has an upper rim, and a flow diffuser is supported on the upper rim. The flow diffuser includes a flow guide and a mounting assembly configured to support the flow guide on the solidification crucible's upper rim.

Feedstock is transferred from the feedstock container to the furnace chamber within the melting furnace via the feed system. The feedstock is melted in the furnace chamber, and molten feedstock then flows through the outlet, through the valve assemblies, and into the solidification crucible within the solidification module. When the solidification crucible is filled to a desired level, the solidification crucible is cooled by the heat sink. When the heat sink is positioned below the crucible, the heat sink receives heat from the solidification crucible and molten feedstock, and the molten feedstock solidifies from the bottom upwards to produce an ingot. In some embodiments, the feedstock is silicon, and directional solidification forms an ingot of multi-crystalline silicon.

In some instances, feedstock is introduced into the melting furnace in a sequential batch-wise process. A first batch of feedstock, e.g., 5-10 kg, is introduced into the melting furnace. Additional batches of feedstock are added until the desired amount of feedstock has been introduced into the melting furnace. The additional batches may have a mass greater than the first batch. The sequential addition of batches minimizes the risk of thermal shock to the liner and resulting damage to the liner. In other instances, a batch of feedstock is introduced into the melting furnace in a continuous manner at a rate greater than a rate of molten feedstock flowing through the outlet.

In other arrangements, the feedstock may be a gaseous form of silicon, and the initial conversion to a solid form of silicon may take place in a chemical reactor, such as a free space reactor. In this process, a pyrolysis reaction decomposes the gaseous silicon-bearing molecule into a solid silicon component, typically a powder, and a gaseous component such as H₂, Cl₂, or HCl (with the latter two being formed in the case of a chlorinated silane). A free space reactor, or other chemical reactor, could be used in place of feedstock container, thereby providing its output directly to the feed system. In still other arrangements, the effluent products from a fluid bed reactor, such as fines and powder, could be directly fed from an effluent gas filter to the feed system.

In some arrangements, a plurality of solidification modules is used with the stationary melting furnace. Once the first solidification crucible has been filled with molten feedstock, the first solidification module can be separated from the melting furnace. A second solidification module then is coupled to the melting furnace, and the process of adding feedstock, melting the feedstock, and filling the second solidification crucible with molten feedstock is repeated. This process can be repeated multiple times using multiple solidification crucibles, thereby increasing the productivity of the system.

In certain arrangements, the melting furnace includes a thermal valve system. In such arrangements, the vicinity of the furnace chamber outlet may be maintained at a temperature below the melting point of the feedstock while the feedstock within the chamber is melted. As molten feedstock begins to flow into the outlet, it solidifies and forms a solid plug within the outlet, thereby preventing flow of the molten feedstock into the solidification module. This arrangement allows the melting furnace to be operated at a vacuum, or partial vacuum, during the melting process so that undesirable gases will be removed as the feedstock melts. Once the feedstock has melted, the melting furnace may be re-pressurized with a process-compatible gas, and the temperature in the vicinity of the outlet is increased above the melting temperature of the feedstock. The plug within the outlet melts, and molten feedstock flows into the solidification crucible within the solidification module.

The foregoing and other features and advantages of the invention will become more apparent from the following detailed description, which proceeds with reference to the accompanying figures.

### BRIEF DESCRIPTION OF THE DRAWINGS

FIG. 1 is schematic cross-sectional elevational view of one embodiment of a system for melting and casting feedstock.

FIG. 2 is a schematic cross-sectional elevational view of one embodiment of a feed system.

FIG. 3 is a schematic cross-sectional elevational view of another embodiment of a feed system.

FIG. 4 is a schematic cross-sectional elevational view of one embodiment of a system for melting and casting feedstock under an inert atmosphere.

FIG. 5 is a schematic cross-sectional elevational view of one embodiment of a system for melting feedstock under an inert atmosphere.

FIGS. 6A-6B are schematic diagrams illustrating one embodiment of a flow diffuser for guiding molten feedstock flow into a crucible.

FIGS. 7A-7D are diagrams illustrating one embodiment of a method for feeding batches of cold powder into a hot furnace.

FIG. 8 is a schematic cross-sectional elevational view of one embodiment of a system for melting feedstock under a vacuum.

FIG. 9 is a schematic cross-sectional elevational view of one embodiment of a system for melting feedstock and filling a crucible.

FIG. 10 is a schematic cross-sectional elevational view of one embodiment of a system for melting feedstock and solidifying molten feedstock.

FIG. 11 is a schematic cross-sectional elevational view of one embodiment of a system for melting and casting feedstock, wherein the system has a removable solidification module.

### DETAILED DESCRIPTION

Disclosed are embodiments of a method and system for melting feedstock and casting ingots. Embodiments of the disclosed method and system are suitable for producing high-value product from low-value and/or waste feedstock. When the system is configured with a compatible furnace liner, or melting crucible, and solidification crucible, suitable feedstocks include metals, metalloids, metal alloys, compounds, and other elements that can be melted and purified through subsequent directional solidification. For example, the feedstock could be silicon, germanium, silicon carbide, or an alloy. The feedstock may be in the form of powder (0.2-15 μm diameter), fines (10-250 μm diameter), granules (0.25 to 3.5 mm diameter) and/or chunks (up to 50 mm diameter).

Unless otherwise stated, all numbers and ranges presented in this application are approximate—within the scientific uncertainty values for the tests required to determine such number values and ranges, as known to those of ordinary skill in the art. Unless otherwise indicated, non-numerical properties such as amorphous, crystalline, and so forth as used in the specification or claims are to be understood as being modified by the term “substantially,” meaning to a great extent or degree.

### I. Melting and Casting Apparatus

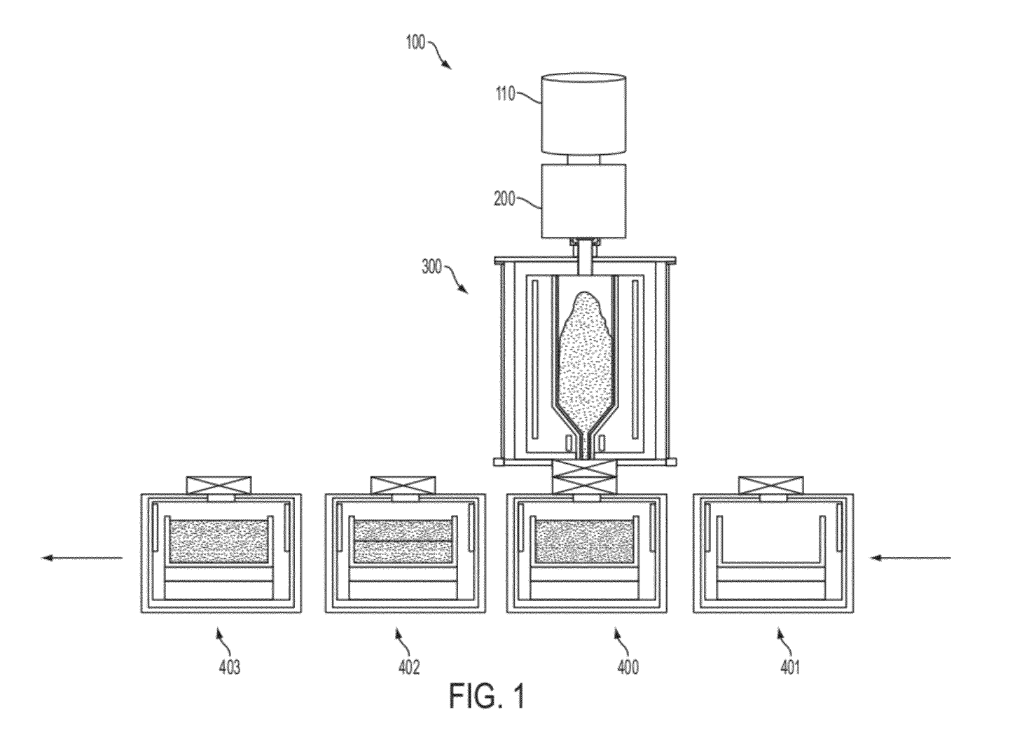

As shown in FIG. 1, one embodiment of a system 100 for melting feedstock and casting ingots includes a feedstock container 110 removably coupled via a feed system 200 to a stationary melting furnace 300. Melting furnace 300 is removably coupled to a solidification module 400. In the illustrated arrangement, melting furnace 300 is stationary, and system 100 includes a plurality of movable solidification modules 400-403 capable of being detachably coupled to melting furnace 300. In such an arrangement, for example, one solidification module 401 may be preheating while another solidification module 400 is coupled to melting furnace 300 and being filled with molten feedstock and yet other solidification modules 402, 403 have been separated from melting furnace 300, and are cooling.

A. Feedstock Container and Feed System

Feedstock container 110 may be any container suitable for holding feedstock. For example, feedstock container 110 may be a rigid intermediate bulk container (RIBC), a flexible intermediate bulk container (FIBC), or a drum. In some arrangements, feedstock container 110 is replaced by a chemical reactor such as a free space reactor, a fluid bed reactor, a plasma skull reactor, or a Siemens reactor (not shown).

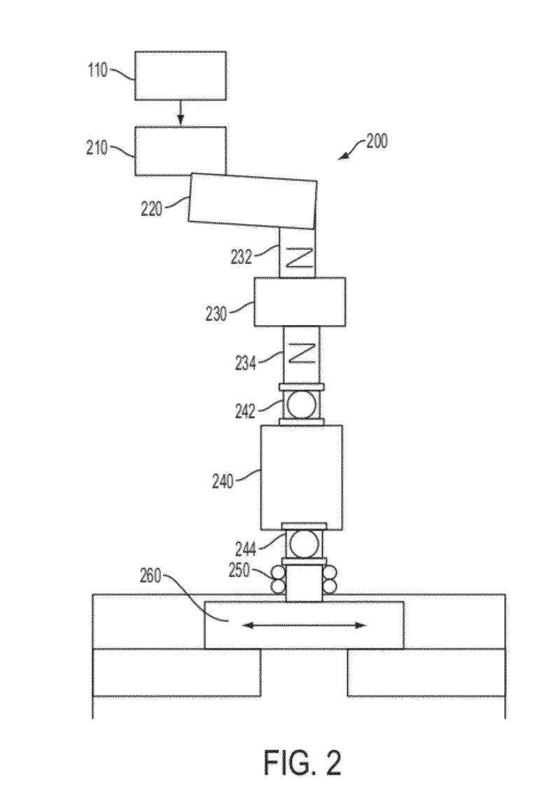

Feedstock container 110 is coupled to stationary melting furnace 300 by a feed system. FIG. 2 illustrates one embodiment of a feed system 200 suitable for supplying feedstock from feedstock container 110 to melting furnace 300. Feed system 200 is coupled to feedstock container 110 using a docking system 210. In some arrangements, docking system 210 is a split butterfly valve (SBV) docking system.

In the arrangement shown in FIG. 2, docking system 210 supplies feedstock to a feeder 220. In some arrangements, feeder 220 is a vibrating feeder. In other arrangements, feeder 220 is a pneumatic feeder. When a filled feedstock container 110 is coupled to docking system 210 and secured, docking system 210 is opened to create a path for feedstock flow from container 110 into feeder 220.

In some embodiments, feedstock container 110 further includes an internal fluidizer (not shown). The internal fluidizer and feeder 220 facilitate flow of feedstock into a gravimetric feeder 230. Gravimetric feeder 230 includes an inlet flow control device 232 and an outlet flow control device 234. Suitable flow control devices 232, 234 include, but are not limited to, rotary, butterfly, iris, inflatable pinch, ball, or gate valves, or other flow control devices.

In a desirable arrangement, gravimetric feeder 230 utilizes flexible thin-walled tubing (not shown) to facilitate use of a weight measurement system unconstrained by the inlet flow control device 232 and outlet flow control device 234. Flexible thin-walled tubes upstream of inlet flow control device 232 and downstream of outlet flow control device 234 allow a load cell or other weight measurement instrument to independently measure the masses of gravimetric feeder 230, flow control devices 232, 234, and the feedstock. With the known fixed masses of gravimetric feeder 230, flow control devices 232, 234 subtracted, the variable mass of the feedstock is obtained. One advantage of this arrangement is the ability to obtain a measurement of the feedstock within a closed system, thereby keeping the feedstock material contained while excluding contaminating oxygen and/or other contaminants from the ambient atmosphere.

Inlet and outlet flow control devices 232, 234 can be opened and closed to isolate a feedstock batch having a desired mass in gravimetric feeder 230. The mass of a feedstock batch may depend, at least in part, on the size and/or capacity of gravimetric feeder 230 and/or subsequent components downstream from gravimetric feeder 230. For example, a feedstock batch may have a mass of 1-100 kg, such as 5-10 kg, 5-20 kg, 5-50 kg, 5-100 kg, 10-20 kg, 10-50 kg, 10-100 kg, 30-50 kg, 30-100 kg, 30 kg, 40 kg, or 50 kg.

Outlet flow control device 234 is coupled to a vacuum lock hopper 240. Vacuum lock hopper 240 is operably coupled to a source of negative pressure such as a vacuum pump (not shown). Vacuum lock hopper 240 can be evacuated to remove undesirable gases such as nitrogen or air from the feedstock. Vacuum lock hopper 240 subsequently can be re-pressurized with a process-compatible gas. The process-compatible gas is a gas that is compatible with melting furnace 300 and further may be an inert gas, a gas that does not react with the feedstock, or even a mixture including a reactive gas that can react with the feedstock or melting byproducts such as SiO formed when silicon is melted. Suitable process-compatible gases may include, but are not limited to, argon, helium, and mixtures of hydrogen with argon and/or helium. Vacuum lock hopper 240 further includes an inlet valve 242 and an outlet valve 244 so that it can be closed tightly during evacuation and re-pressurization. In some embodiments, valves 242, 244 are ball valves as shown in FIG. 2. Ball valves provide a tight closure and have minimal flow resistance when opened. However, other valves also may be suitable.

Vacuum lock hopper 240 is connected to melting furnace 300 via a feed pipe 250. Desirably, feed pipe 250 is cooled to protect outlet valve 244 from heat generated in the melting furnace. Excessive heat could potentially damage the seals of valve 244 and/or result in fouling of the discharge path with sintered or melted residual feedstock. In some embodiments, feed pipe 250 is cooled with an active cooling system. For example, feed pipe 250 may be water cooled. Further protection from excessive temperatures is provided by a movable insulation gate 260 between feed pipe 250 and melting furnace 300.

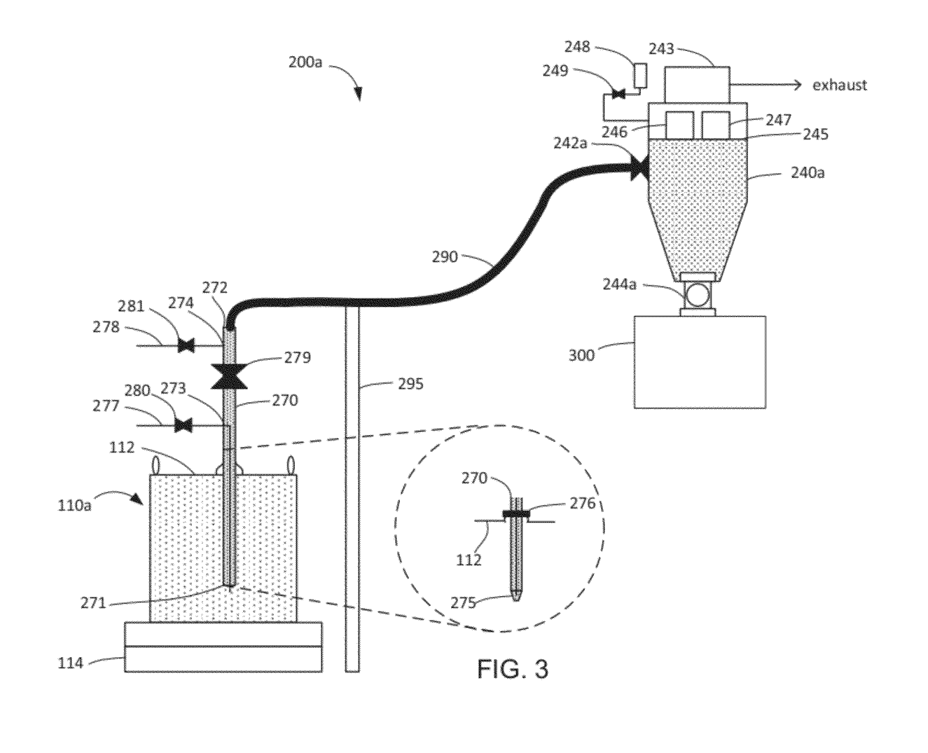

FIG. 3 illustrates another embodiment of a feed system 200a. Powdered feedstock is transferred from a feedstock container 110a (e.g., a flexible intermediate bulk container at ground level) to vacuum lock hopper 240a. In some arrangements, feedstock container 110a is placed on a scale 114. A powder transfer suction tube 270 is placed into feedstock container 110a. The powder transfer suction tip has an open first end 271, an open second end 272, a gas flow inlet 273, and a hose flush inlet 274. In one arrangement (inset), powder transfer suction tube 270 has a tapered tip 275 to facilitate penetration of the feedstock container's flexible liner 112 and ensure that liner 112 tightly encircles powder transfer suction tube 270. A band clamp 276 may be used to further secure a tight fit between liner 112 and powder transfer suction tube 270. Powder transfer suction tube 270 is connected to vacuum lock hopper 240 via a vacuum transfer hose 290. A hose support 295 may be used to support vacuum transfer hose 290. A first gas inflow line 277 is in fluid communication with powder transfer suction tube 270 via gas flow inlet 275. A second gas inflow line 278 is in fluid communication with powder transfer suction tube 270 via hose flush inlet 274, which is positioned above flow inlet 273. Powder transfer suction tube 270, gas inflow line 277, and hose flush line 278 further include valves 279, 280, 281, which can be opened and closed as desired during operation. Valve 279 is positioned between inlet 273 and inlet 274.

Vacuum transfer hose 290 is in fluid communication with vacuum lock hopper 240 via inlet valve 242. A source of negative pressure 243, e.g., a pneumatic vacuum pump, is operably coupled to vacuum lock hopper 240 by any suitable means. Desirably, vacuum lock hopper 240 includes a divider 245 and filter elements 246, 247 to prevent powder aspiration into vacuum source 245 during operation. A filter blowback flask 248 also may be coupled to vacuum lock hopper 240 above divider 245. Valve 249, e.g., a fast-acting valve, can be opened to clean filter elements 246, 247 by blowing clean gas (e.g., argon) back through the filters. When valve 249 is opened, a pressure impulse is provided on the downstream side of filter elements 246, 247, which temporarily reverses flow such that accumulated feedstock falls from the elements. This cleaning action maintains suitable flow through filter elements 246, 247. Valve 249 may be opened at regular periodic intervals, such as prior to each transfer cycle, or may be opened based on a high differential pressure signal.

B. Melting Furnace and Solidification Module

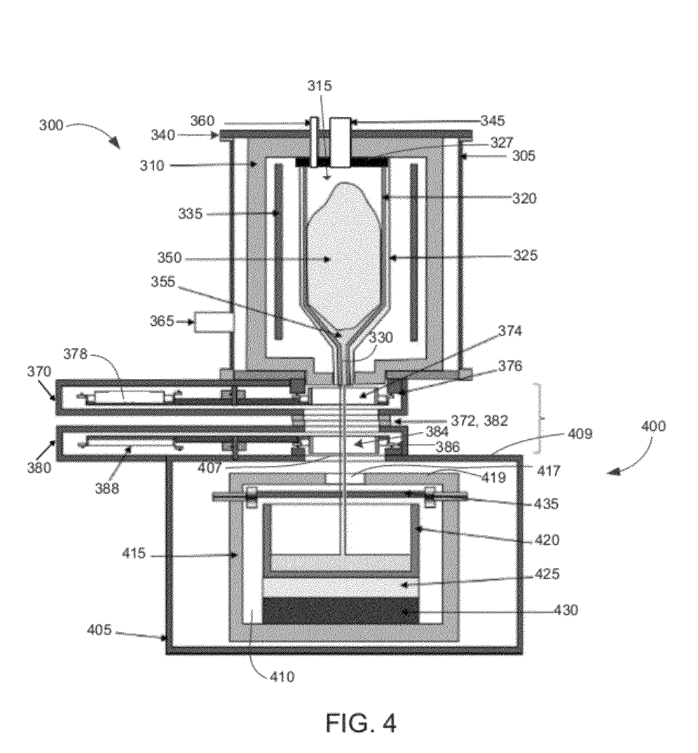

FIG. 4 illustrates one embodiment of a stationary melting furnace 300 and movable solidification module 400 suitable for melting feedstock and casting ingots. Melting furnace 300 has an outer shell 305. An insulation layer 310 is positioned inwardly of shell 305. In some arrangements, insulation layer 310 is constructed of graphite. A furnace chamber 315 is defined by a vessel having walls. In the embodiment shown in FIG. 4, the vessel comprises a liner 320 and a liner support 325.

Suitable liner support materials include graphite. In some arrangements, liner 320 is constructed of quartz. In particular arrangements, a single-piece, slip-cast fused silica liner is used. In other arrangements, fused quartz segments may be joined together by suitable means (e.g., welding, clamping, stacking) to form liner 320. Desirably, the fused quartz segments are joined intimately, such as by welding, in the lower portion of the liner where molten feedstock will contact the liner. Fused quartz/fused silica liners have advantageous thermal and material properties. At the expected operating temperature, i.e., with the maximum temperature being greater than the melting point of the feedstock (for example, 1414° C. when the feedstock is silicon), and perhaps as high as 1450° C., 1500° C., or 1550° C., the fused silica structure initially is amorphous. Over time, the fused silica de-vitrifies and slowly forms trydimite and beta cristobalite at temperatures between 870° C. and 1450° C. Above 1450° C., the fused silica would more rapidly transform into beta cristobalite. When cooled, beta cristobalite is metastable; if it does not cool below 275° C., it will not transform into alpha cristobalite. Any beta quartz present will not change phase to alpha quartz if the temperature is maintained above 1063° C. Once heated to a maximum operating temperature of 1450-1550° C., liner 320 will easily tolerate temperature reductions of 200-300° C. without phase changes that could potentially cause breakage.

In the system shown in FIG. 4, an upper portion of furnace chamber 315 is defined by a substantially vertical side wall and has substantially constant horizontal dimensions. In a lower portion of furnace chamber 315, the side wall has an inner surface that is conical and tapers downwardly to an outlet 330. One or more furnace heating element(s) 335 is positioned between liner support 325 and insulation layer 310. Melting furnace 300 further includes a top wall 340. A feed port 345 extends through top wall 340 and insulation layer 310 such that unmelted feedstock 350 can be introduced through feed port 345 into furnace chamber 315. Molten feedstock 355 flows out of furnace chamber 315 through outlet 330. A gas inlet 360 also extends through top wall 340 and insulation layer 310 into furnace chamber 315. Gas inlet 360 is used to introduce a process-compatible atmosphere (e.g., argon, helium, or a mixture of hydrogen with argon and/or helium) into furnace chamber 315. A vacuum port 365 extends through furnace shell 305. When insulation layer 310 is graphite, the insulation layer is porous and vacuum port 365 is in fluid communication with furnace chamber 315.

Melting furnace 300 may further include a loose-fitting lid 327, or cap, positioned on top of the furnace chamber 315. Lid 327 defines at least two apertures to accommodate the feed port 345 and the gas inlet 360. Lid 327 typically is constructed of the same material as liner 320. Advantageously, lid 327 provides a barrier between insulation layer 310 and liner 320 to prevent contamination of liner 320 and/or furnace chamber 315 with material from insulation layer 310.

A solidification module 400 is positioned to receive molten feedstock from melting furnace 300. The illustrated melting furnace 300 is coupled to solidification module 400 via a docking assembly comprising valve assemblies 370, 380. In some arrangements, e.g., as shown in FIG. 4, valve assemblies 370, 380 are rotating valve assemblies. Other valve assemblies also are suitable such as gate valve assemblies, for example. Advantageously, valve assembly 370 is coupled to melting furnace 300, and valve assembly 380 is coupled to solidification module 400. Valve assemblies 370, 380 have mating surfaces 372, 382 that face one another when the valve assemblies 370, 380 are coupled. In FIG. 4, rotating valve assemblies 370, 380 are shown in the open position 374, 384 allowing molten feedstock 355 to flow into solidification module 400. Rotating valve assemblies 370, 380 include inflatable seals 376, 386, which can be deflated to allow rotation of the valve assemblies into the open position 374, 384 as shown. Inflatable seals 376, 386 are then inflated to keep the sealing surfaces clean and prevent any molten feedstock 355 or byproducts (e.g., SiO) from being transported into the rotating valve internal structures. Rotating valve assembly 370 further includes a drip pan 378. When rotating valve assembly 370 is in a closed position (not shown), drip pan 378 receives any molten feedstock 355 passing through outlet 330. When rotating valve assembly 380 is in a closed position (not shown), a cover 388 prevents molten feedstock 355 from passing into solidification module 400.

In some arrangements, the docking assembly comprising valve assemblies 370, 380 further includes a vacuum port (not shown). The vacuum port enables any air admitted to the space between the valves during the docking process to be evacuated prior to opening the valves.

Solidification module 400 includes an outer shell 405 having an aperture 407 in its upper wall 409. Desirably, aperture 407 is substantially centrally located in upper wall 409. An inner chamber 410 is defined by an insulation layer 415 positioned inwardly of outer shell 405. Insulation layer 415 has an aperture 417 located in its upper wall 419 through which molten feedstock 355 can flow. Aperture 417 is positioned below aperture 407. In some arrangements, insulation layer 415 is constructed of graphite. A solidification crucible 420 is positioned in inner chamber 410. Solidification crucible 420 defines a cavity with an upwardly facing opening located below aperture 417. In some arrangements, solidification crucible 420 is constructed of fused silica. Solidification crucible 420 further may have a coating (not shown) on its inner surfaces, such as a silicon nitride coating. As illustrated in FIG. 4, solidification crucible 420 is supported by a crucible support 425 and a heat sink 430, which absorbs heat directly from crucible support 425, and indirectly from solidification crucible 420 and molten feedstock within the solidification crucible. One or more heating element(s) 435 is positioned in inner chamber 410. In some arrangements, as shown in FIG. 4, heating element 435 is positioned above solidification crucible 420. In other arrangements, one or more heating element(s) 435 may be positioned around solidification crucible 420. Advantageously, heating element 435 is positioned such that molten feedstock 355 flowing through aperture 417 does not contact the heating element. Heating element 435 raises the temperature within solidification crucible 420 to a desired filling temperature. In some arrangements, heat sink 430 is a heat exchanger (i.e., a device capable of transferring heat from a fluid on one side of a barrier to a fluid on the other side of the barrier without bringing the two fluids into direct contact), and after solidification crucible 420 is filled to a desired level with molten feedstock 355, a cooling medium (e.g., water or a cooled process gas such as argon) is flowed through the heat exchanger to begin the solidification process. When molten feedstock 355 is silicon, heat sink 430 is positioned beneath solidification crucible 420 to provide directional solidification, thereby producing a multi-crystalline silicon ingot. In some arrangements, solidification module 400 further includes a vacuum port (not shown) to facilitate more efficient removal of air following installation of solidification crucible 420 and/or following coupling of solidification module 400 to melting furnace 300.

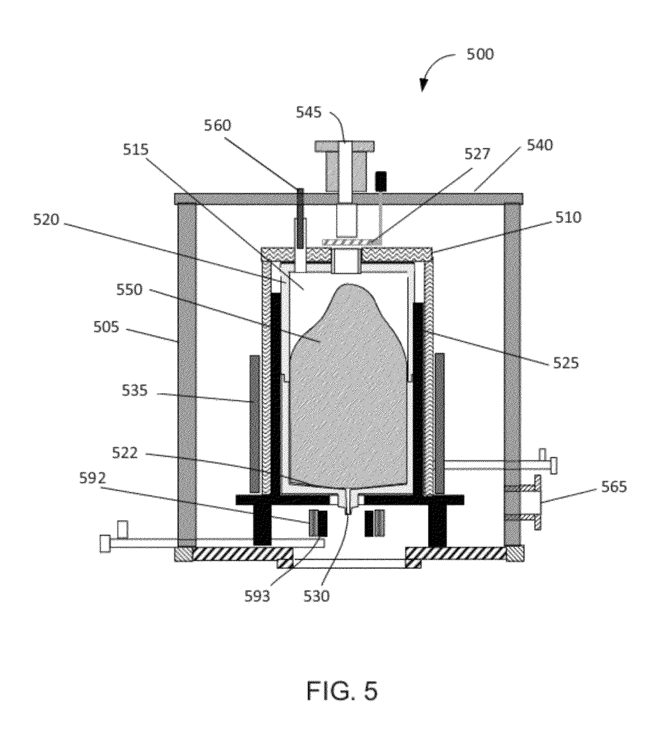

FIG. 5 illustrates another embodiment of a melting furnace 500. Melting furnace 500 has an outer shell 505. A furnace chamber 515 is defined by vessel having walls, e.g., a melting crucible 520. Melting crucible 520 is supported by a susceptor 525. In some arrangements, melting crucible 520 is constructed of quartz, e.g., fused quartz segments. Fused quartz segments may be joined together by suitable means, e.g., welding, clamping, stacking. Suitable susceptor materials include graphite. An insulation layer 510 is positioned outwardly of susceptor 525.

As shown in FIG. 5, an upper portion of furnace chamber 515 is defined by a substantially vertical side wall of melting crucible 520. A lower portion of furnace chamber 515 is defined by a lower wall of melting crucible 520 that has an upper surface 522, which is generally conical and tapers downwardly toward an outlet 530.

One or more heating furnace element(s) 535 is positioned outwardly of insulation layer 510. In some arrangements, heating element(s) 335 is an induction heating element, e.g., one or more induction coils. Positioning induction coil(s) outside the insulation layer may reduce degradation through contamination with feedstock dust or byproducts (e.g., SiO when the feedstock is silicon). The induction coil(s) also may be cooled (e.g., by water cooling), thereby allowing the heating element to operate at a lower temperature than a resistive heating element placed between the insulation layer and the furnace chamber.

Melting furnace 500 further includes a top wall 540. A feed port 545 extends through top wall 540 and insulation layer 510 such that unmelted feedstock 550 can be introduced through feed port 545 into furnace chamber 515 defined by melting crucible 520. Molten feedstock flows out of furnace chamber 515 through outlet 530. A gas inlet 560 also extends through top wall 540 and insulation layer 510 into furnace chamber 515. Gas inlet 560 is used to introduce a process-compatible atmosphere (e.g., argon, helium, or a mixture of hydrogen with argon and/or helium) into furnace chamber 515. A vacuum port 565 extends through furnace shell 505. When insulation layer 510 is graphite, the insulation layer is porous, and hence vacuum port 565 is in fluid communication with furnace chamber 515.

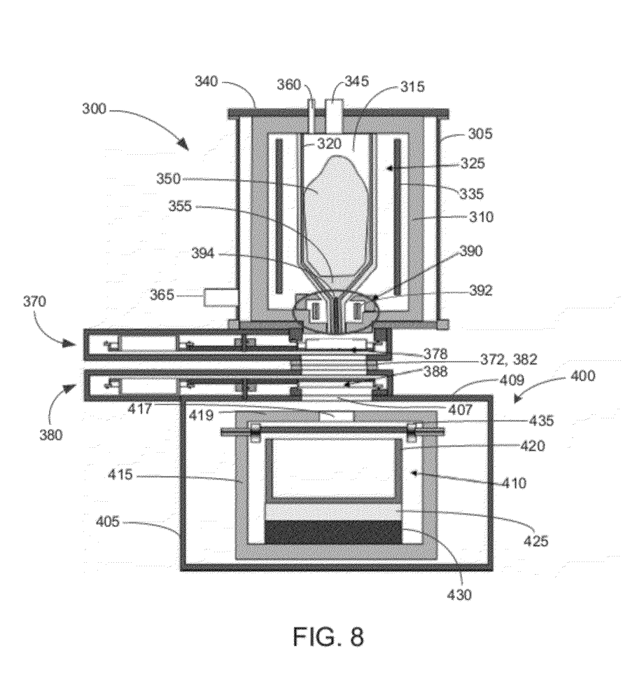

Melting furnace 500 may further include a loose-fitting lid 527, or heat shield, positioned on top of the furnace chamber 515. Heat shield 527 is slidable and is moved to permit feedstock to be introduced through feed port 545. Melting furnace 500 also may include a thermal valve system comprising outlet 530 and one or more heating elements 592. In one arrangement, heating element 592 is one or more induction coils, a susceptor 593 is positioned inwardly of heating element 592, and an insulation layer (not shown) is positioned between heating element 592 and susceptor 593. As described below in detail with respect to FIG. 8, the thermal valve system may be held at a temperature below the melting point of the feedstock as feedstock 550 is being melted in melting crucible 520. Molten feedstock flows into outlet 530 and solidifies, thereby preventing flow of molten feedstock into the solidification module (not shown). When substantially all of feedstock 550 is melted, heating elements 592 may be used to increase the temperature within outlet 530 above the melting point of feedstock 550 to melt feedstock within outlet 530 and initiate flow into the solidification module.

A vertical flow of molten feedstock into a solidification crucible 420 of the type shown in FIG. 4 may produce splatter. Splatter would result in a reduced yield from splatter that does not enter solidification crucible 420, and may degrade surrounding components. For example splatter making contact with heating element 435 and falling back into solidification crucible 420 could both damage heating element 435 and cause product contamination. Thus, in some arrangements, a flow diffuser is used to reduce or eliminate splatter by absorbing kinetic energy from the free-falling molten feedstock.

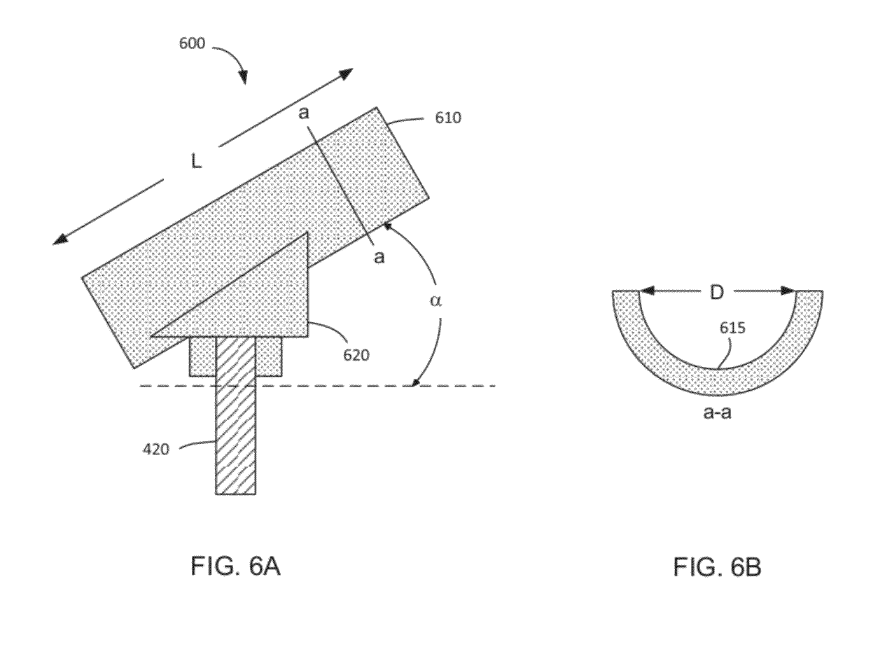

FIGS. 6A and 6B are schematic diagrams illustrating one embodiment of a flow diffuser 600. Flow diffuser 600 includes a flow guide 610 and a mounting apparatus 620 for removably attaching flow guide 610 to an upper rim of crucible 420. Flow diffuser 600 is positioned to receive molten feedstock as it flows through valve assembly 380, and guides the molten feedstock into solidification crucible 420. In some embodiments, flow diffuser 600 is a “half-pipe diffuser” wherein flow guide 510 has a shape substantially similar to one half of a cylindrical pipe cleaved through a plane extending along its longitudinal axis. FIG. 6B illustrates a cross-section of the half pipe configuration of flow guide 610.

Depending on the discharge conditions from melting furnace 300, including the flow rate, flow resistance through outlet 330, viscosity of the molten feedstock, the free-fall height, free-fall path atmospheric conditions (e.g., temperature, pressure, and gas composition), and surrounding chamber 400 thermal conditions, the resulting flow stream is expected to be confined to an envelope generally defined by a parabola rotated about the vertical drop axis. Furthermore, as a continuous flow stream driven by surface tension forms droplets, small droplets can be ejected with a horizontal velocity component and a resulting trajectory pushing the droplets into an even larger flow dispersion envelope. To capture the majority of the flow stream, flow guide 610 has a diameter D equal to or greater than the flow dispersion envelope. In some embodiments, diameter D is at least 75 mm, at least 100 mm, or at least 125 mm, such as 75-200 mm or 100-150 mm. In one embodiment, diameter D is 125 mm.

Flow diffuser 600 is constructed such that flow guide 610 is at an angle α relative to a horizontal plane when the flow diffuser is mounted on the rim of solidification crucible 420. In some arrangements, angle α is between 30 and 60 degrees from horizontal, such as 30 degrees, 45 degrees, or 60 degrees from horizontal. A half-pipe configuration for flow guide 610 with the concave side, or inner surface 515, facing up and the flow guide positioned at an angle of 30-60 degrees from horizontal provides a desirable arrangement to absorb kinetic energy from the flow stream of molten feedstock. With flow guide 610 oriented in this manner, none of its surface lies on a plane normal to the flow path of the molten feedstock. As molten feedstock flows along inner surface 615 of flow guide 610, kinetic energy is dispersed with the work done through the shearing of the viscous fluid across a boundary layer between the moving fluid and inner surface 615. Additionally, the upward sloping sides of a half pipe configuration contain the fluid dispensed perpendicular to the half pipe's longitudinal axis and channel the flow to the center as it is dispensed to solidification crucible 420 below.

A person of ordinary skill in the art will understand that the length L of flow guide 610 may depend, at least in part, on the distance between valve assembly 380 and solidification crucible 420 and the angle α at which flow guide 610 is disposed relative to horizontal. In some embodiments, flow guide 610 is at least 100 mm long, at least 200 mm long, or at least 400 mm long, such as 100 mm to 800 mm, 150 mm to 500 mm, 150 mm to 200 mm, or 400 mm to 500 mm. In some embodiments, flow guide 610 has a length that is twice its diameter D. Thus, in some embodiments, flow guide 610 has a diameter of at least 50 mm, at least 100 mm, or at least 200 mm, such as 50 mm to 400 mm, 75 mm, to 250 mm, 75 mm to 100 mm, or 200 mm to 250 mm.

In some arrangements, flow guide 610 is constructed of fused silica or comprises a fused silica liner, such as a single-piece, slip-cast fused silica liner. In one arrangement, flow guide 610 is constructed of a machineable fused silica insulating foam, e.g., Zyafoam® (Vesuvius USA, Dillon, S.C.). When the molten feedstock comprises silicon, the weak hydrophilic interaction between molten silicon and fused silica coupled with the relatively high surface tension of molten silicon produces an incident flow path downward along inner surface 615 of flow guide 610 with little-to-no flow reflected or otherwise separated from surface 615 near the point of impact, i.e., the point at which the vertically downward flowing molten silicon contacts flow guide 610 after passing through valve assembly 380.

### II. Melting and Casting Process

FIG. 1 illustrates how feedstock is transferred from feedstock container 110 to feed system 200 and then into melting furnace 300. In the arrangement of FIGS. 1 and 2, feedstock flows from the feedstock container 110 by gravity. In another arrangement illustrated in FIG. 3, feedstock is transferred from feedstock container 110a to feed system 200a and then into melting furnace 300 by pneumatic transport. The feedstock is melted in melting furnace 300 and flows into solidification module 400 where it is directionally solidified. Advantageously, the illustrated melting furnace 300 is stationary and solidification module 400 is movable.

Using the apparatus of FIG. 2, powder, fines, granules, and/or chunks are delivered from feedstock container 110 to split butterfly valve (SBV) docking system 210 by gravity and then into feeder 220. Feeder 220 is activated to assist flow of feedstock into gravimetric feeder 230. In some arrangements, outlet flow control device 234 is closed until a desired mass of feedstock (e.g., 1-100 kg) has flowed into gravimetric feeder 230. Once the desired mass is reached, inlet flow control device 232 is closed. Outlet flow control device 234 then is opened, and the feedstock batch flows into vacuum lock hopper 240.

Using a source of negative pressure, for example as provided by a vacuum pump (not shown), vacuum lock hopper 240 is evacuated to remove undesirable gases (e.g., nitrogen, oxygen) from the feedstock. Vacuum lock hopper 240 then is re-pressurized with a process-compatible gas as previously described. Vacuum lock hopper 240 can be re-pressurized to a target pressure suitable for melting furnace 300. In some arrangements, vacuum lock hopper 240 may be maintained at a high vacuum, such as a vacuum between 1×10⁻¹ mbar and 1×10⁻¹⁰ mbar, or between 1×10⁻¹ mbar and 1×10⁻² mbar. In other arrangements, vacuum lock hopper 240 may be re-pressurized to a partial vacuum or atmospheric pressure. In particular arrangements, vacuum lock hopper 240 is re-pressurized to a pressure slightly greater than that within melting furnace 300 to provide a driving differential pressure to assist gravity as feedstock flows from vacuum lock hopper 240 to melting furnace 300. Outlet 244 and movable insulation gate 260 then are opened to allow feedstock to flow through feed pipe 250 into melting furnace 300.

Using the apparatus of FIG. 3, a powder transfer suction tube 270 is inserted into a feedstock container 110a holding powder. Powder transfer suction tube 270 may be inserted manually into feedstock container 110a. Alternatively, an automated device (not shown) may be coupled to powder transfer suction tube 270 to automatically insert the tube into feedstock container 110a. Valves 279, 280 are opened, and inert gas (e.g., argon) flow is initiated through first gas inflow line 277. The gas flow is adjusted to at least partially fluidize the feedstock so that a mixture of feedstock and gas can enter powder transfer suction tube 270. The gas flow also is maintained at a rate sufficient to prevent collapse of liner 112 as feedstock in feedstock container 110a is depleted. Valve 242 is opened and negative-pressure source 243 is activated to initiate transfer of feedstock/inert gas through powder transfer suction tube 270 and vacuum transfer hose 290. The mass of transferred feedstock can be monitored with scale 114. Once a desired mass of feedstock has flowed into vacuum lock hopper 240, valves 279, 280 are closed and inert gas flow through first gas inflow line 277 is stopped. Valve 281 is opened and inert gas is flowed through second gas inflow line 278 to flush residual powder through vacuum hose 290 and into vacuum lock hopper 240. Valves 242, 281 are then closed and gas flow through second gas inflow line 278 is stopped. Negative-pressure source 243 may continue to operate for a period of time to remove any undesirable gases from the transferred feedstock. Vacuum lock hopper 240 then is re-pressurized as described above to transfer feedstock into melting furnace 300.

In some embodiments, a batch process is utilized to maximize production capacity and minimize costs. In a batch process, melting furnace 300 is maintained at a high temperature (e.g., a maximum temperature at least 1414° C. and up to 1450° C., 1500° C., or 1550° C. when the feedstock is silicon) throughout the casting process as relatively cold feedstock is added to the furnace. To minimize thermal shock to liner 320 and control the overall mass of feedstock added to melting furnace 300, a sequential batch feeding process can be used.

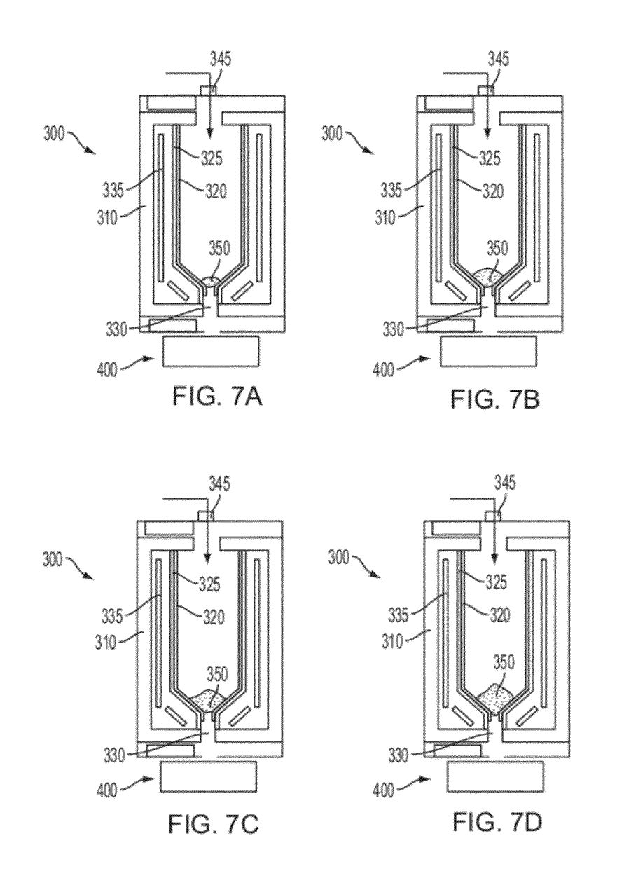

FIGS. 7A-7D illustrate one embodiment of a sequential batch feeding process. As shown in FIG. 7A, a small initial batch (e.g., 5-10 kg) of feedstock 350 is loaded into furnace chamber 315 via inlet 345. All material deposited from this batch and making contact with liner 320 has the potential of thermally shocking liner 320. However, powdered feedstock with its small particles and low bulk density typically has a relatively low thermal conductivity. The surface of the feedstock mass 350 making initial contact with quartz/silica liner 320 will immediately draw thermal energy from liner 320, but due to the low thermal conductivity, the bulk of the feedstock volume will not draw thermal energy from liner 320, thereby limiting the magnitude of the thermal shock. The thermal mass of liner 320 along with the thermal mass of graphite liner support 325 provides the system with sufficient thermal capacity to limit thermal shock and minimize risk of breakage.

Subsequent batches of feedstock 350 loaded into furnace chamber 315 would have a large fraction fall onto previously added feedstock 350. With its low thermal conductivity, the feedstock already present in furnace chamber 315 functions as an excellent thermal buffer for liner 320. A minor amount of thermal shock occurs to surfaces freshly wetted with feedstock 350, but the effects are limited. Thus, with the buffering effect of the feedstock 350 already present in furnace chamber 315, increasing quantities of additional feedstock 350 can be safely loaded without excessive temperature reductions and thermal shock to liner 320. Thus, in some arrangements, a larger second batch of feedstock 350 having a mass of 10-20 kg, for example, can be added to furnace chamber 315 (FIG. 7B). Subsequent batches can be even larger, e.g., 30-50 kg (FIGS. 7C and 7D). In other arrangements, each sequential batch may be of substantially similar mass.

In some arrangements, a feedstock batch of desired mass is premeasured into feedstock container 110, gravimetric feeder 230, and/or vacuum lock hopper 240. For example, the batch may have a mass sufficient to fill a single crucible 420 when the feedstock is melted. The feedstock batch then is introduced through feed system 200 and into melting furnace 300 in a continuous manner. Desirably, the feedstock is introduced into melting furnace 300 at a rate greater than a rate of molten feedstock flowing through outlet 330 and into solidification module 400. Introducing feedstock into the melting furnace at a rate at least slightly greater than the rate of feedstock outflow ensures that at least some unmelted feedstock remains in furnace chamber 315, thereby protecting liner 320 from thermal shock as described above.

A solidification module 400 is positioned to receive molten feedstock from stationary melting furnace 300. Solidification module 400 is coupled, or docked, to melting furnace 300 via rotating valve assemblies 370, 380 (FIG. 4). In one embodiment, a flow diffuser 500 (FIG. 6A) is removably attached to an upper rim of crucible 420 before solidification module 400 is coupled to melting furnace 300. In some arrangements, solidification module 400 is coupled to melting furnace 300 before feedstock 350 is loaded into melting furnace 300. In other arrangements, solidification module 400 is coupled to melting furnace 300 while feedstock 350 is being loaded. After docking, void spaces between and within rotating valve assemblies 370, 380 are evacuated or purged with a process-compatible gas, e.g., argon. Before flow of molten feedstock 355 is initiated, inflatable seals 376, 386 are deflated and rotary valve assemblies 370, 380 are rotated into open position as shown in FIG. 4. Once positioned, inflatable seals 376, 386 are re-inflated to keep the sealing surfaces clean and prevent any molten feedstock or melting byproduct (e.g., SiO) from contacting internal structures of the rotating valve assemblies. Melting furnace 300 and solidification chamber 400 are pressurized to a desired level via gas inlet 360. In some embodiments, melting furnace 300 and solidification chamber 400 are pressurized to 400-800 mbar, such as to 600 mbar, with a process-compatible atmosphere.

In some embodiments, solidification chamber 400 is preheated to a desired temperature before being coupled to melting furnace 300. Once coupled, solidification chamber 400 can be heated to its filling temperature (e.g., 1414° C.-1550° C. when the feedstock is silicon) while feedstock 350 is added to melting furnace 300. In certain embodiments, solidification chamber 400 is preheated to its filling temperature before being coupled to melting furnace 300.

Molten feedstock 355 is formed as heat is transferred from furnace heating element 335 through liner support 325 and liner 320 to feedstock 350. Molten feedstock 355 then flows through outlet 330, through valve assemblies 370, 380, and into preheated crucible 420. When flow diffuser 500 is utilized, molten feedstock 355 flows through outlet 330, through valve assemblies 370, 380, and into flow guide 510. Molten feedstock then flows downward through flow guide 510 and into preheated crucible 420.

As previously mentioned, solidification crucible 420 may include a coating, such as a silicon nitride coating (not shown), on its inner surfaces. In some embodiments, it is advantageous to melt feedstock under a stronger vacuum than can be tolerated by the silicon nitride coating. Melting feedstock under a vacuum facilitates expulsion and removal of any byproducts (e.g., SiO when the feedstock is silicon) potentially formed from partially oxidized feedstock. To provide the means to melt feedstock under vacuum, melting furnace 300 may include a thermal valve system 390 as shown in FIG. 8. Thermal valve system 390 comprises outlet 330 and one or more heating element(s) 392. Advantageously, thermal valve system 390 is held at a temperature below the melting point of the feedstock (e.g., 1414° C. when the feedstock is silicon) but at a temperature that will minimize the risk of phase changes and/or breakage of liner 320. In some embodiments, the feedstock is silicon and thermal valve system 390 is maintained at a temperature of 1200° C. by thermal valve heating element 392. As feedstock 350 is melted in furnace chamber 315, molten feedstock 355 flows into outlet 330 and solidifies, thereby forming a plug 394 and preventing flow of molten feedstock 355 into valve assembly 370. Valve assemblies 370, 380 typically are in the closed position as shown in FIG. 8 while feedstock 350 is being melted under vacuum. Thermal valve system 390 allows melting furnace 300 to melt feedstock 350 at an independent pressure from solidification module 400 without relying on a mechanical valve to hold back molten feedstock. Thermal valve system 390 also allows valve assemblies 370, 380 to provide a vacuum pressure boundary without being subjected to the high temperatures of molten feedstock.

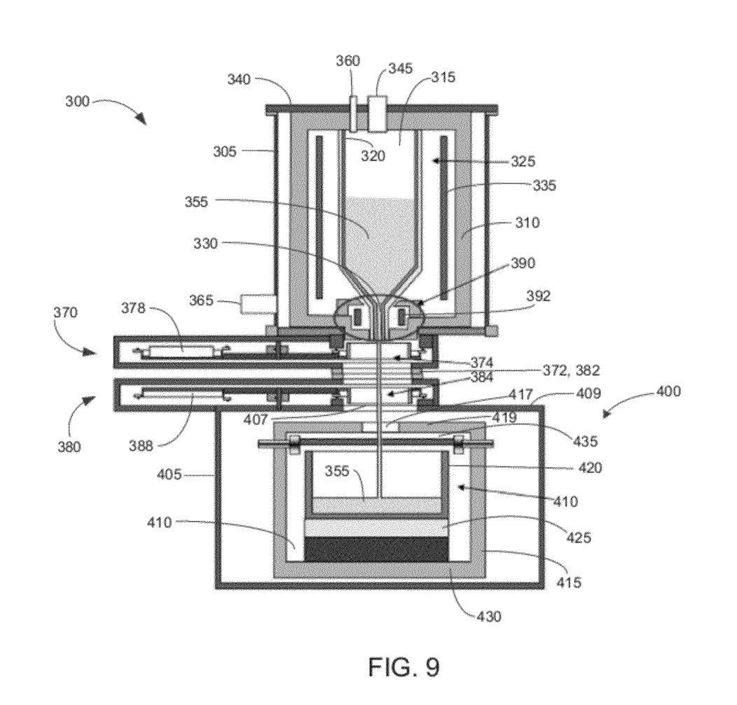

With reference to FIG. 9, when substantially all of feedstock 350 is melted, thermal valve system 390 is heated to a temperature above the melting point of the feedstock, e.g., 1450° C. when the feedstock is silicon. In some arrangements, melting furnace 300 is re-pressurized before plug 394 melts. For example, melting furnace 300 may be re-pressurized to a pressure substantially similar to the pressure in solidification module 300. In some embodiments, melting furnace 300 is pressurized to 600 mbar with a process-compatible gas, e.g., argon. Valve assemblies 370, 380 are then moved into open position, plug 394 melts, and a flow of molten feedstock 355 into solidification crucible 420 is established.

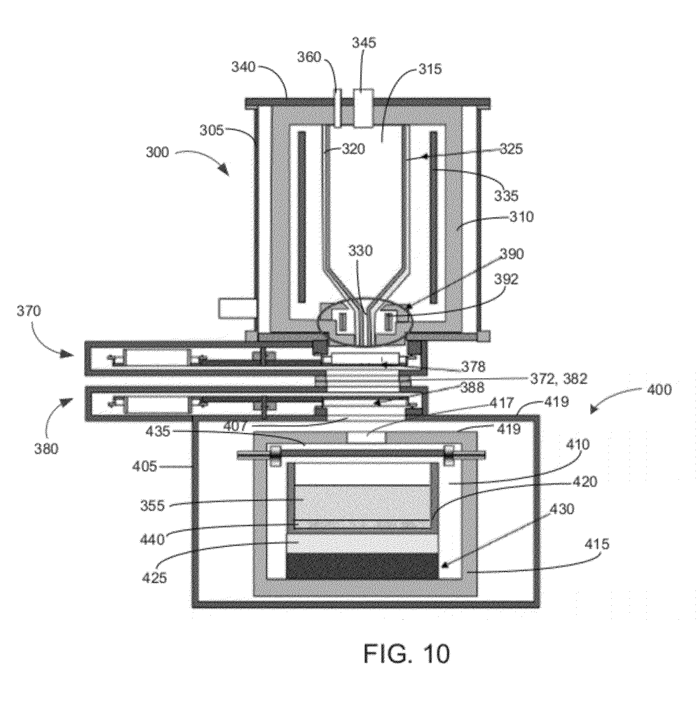

With reference to FIG. 10, when substantially all of the molten feedstock 355 has flowed into solidification module 400, thermal valve system 390 is cooled to a temperature below the melting point of the feedstock. In some embodiments, the feedstock is silicon and thermal valve system 390 is cooled to 1200° C. Valve assemblies 370, 380 are then closed. When heat sink 430 is a heat exchanger, a flow of cooling medium through the heat exchanger is established to initiate a directional solidification process. As heat sink 430 receives heat from crucible support 425 and crucible support 425 cools below the melting temperature of the feedstock, crystallization begins at the bottom of solidification crucible 420 and a layer of solidified feedstock 440 forms. As cooling continues, the layer of solidified feedstock 440 grows upward until all of the molten feedstock 355 has crystallized.

In some embodiments, the feedstock comprises silicon, and an ingot comprising silicon is cast. The silicon feedstock may comprise at least 75% silicon, such as at least 80%, at least 90%, at least 95%, at least 96%, at least 98%, at least 99%, at least 99.5%, at least 99.9%, at least 99.95%, at least 99.99%, or at least 99.995% silicon. In one embodiment, the feedstock consists essentially of silicon. In another embodiment, the feedstock comprises silicon carbide. The ingot produced may comprise at least 75% silicon, such as at least 80%, at least 90%, at least 95%, at least 96%, at least 98%, at least 99%, at least 99.5%, at least 99.9%, at least 99.95%, at least 99.99%, or at least 99.995% silicon. In one embodiment, the feedstock consists essentially of silicon, and the ingot produced consists essentially of multicrystalline silicon. In another embodiment, the feedstock comprises silicon carbide, and the ingot produced comprises silicon carbide.

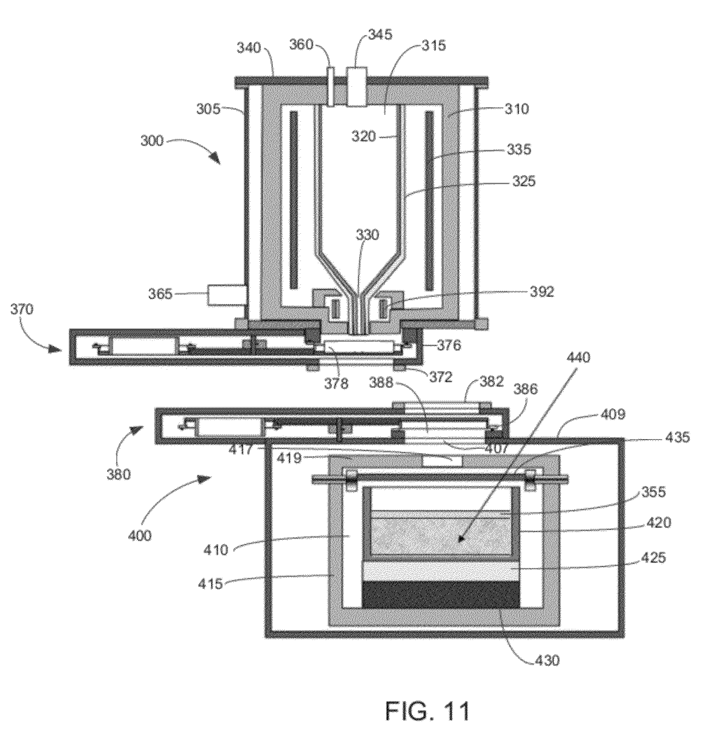

Since the solidification process typically requires several hours to complete, one way to enhance production capacity is to use two or more removable solidification modules 400. As shown in FIG. 11, solidification module 400 is separated from melting furnace 300 so that the melting/casting process can be repeated with another solidification module. In some arrangements (as shown in FIG. 1), a plurality of solidification modules 400-403 are used. Solidification module 400 is uncoupled from stationary melting furnace 300 when solidification crucible 420 is filled. A preheated solidification module 401 is moved into position and coupled to melting furnace 300, and the melting/filling process is repeated. Meanwhile, uncoupled solidification module(s) 402, 403 are cooled by heat sink 430, and molten feedstock 355 directly solidifies to form solidified feedstock 440.

A plurality of removable solidification modules may be positioned upon a transport device (e.g., a conveyor) that moves a first solidification module into position under the stationary melting furnace for filling, stops while the crucible is being filled, and then moves the first solidification module away from the melting furnace while a subsequent solidification module is moved into position for filling. While one solidification module is being uncoupled and another solidification module is being coupled to the melting furnace, the temperature of the melting furnace's thermal valve may be reduced so that a solidified plug forms in the melting furnace outlet, thereby preventing further flow of molten feedstock during the uncoupling/coupling process. The valve assemblies are closed while the solidification modules are being coupled and uncoupled to the melting furnace.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method for melting feedstock comprising silicon and casting an ingot, the method comprising:
providing a stationary melting furnace comprising a vessel having walls that define a chamber, the vessel having an inlet to receive feedstock into the chamber and an outlet, and a solidification module comprising a solidification crucible that defines an upwardly opening cavity;
positioning the solidification module to receive molten feedstock from the stationary melting furnace;
introducing feedstock comprising silicon into the stationary melting furnace, wherein the feedstock comprises powder, fines, granules, chunks, or any combination thereof;
heating the feedstock to a sufficient temperature to produce molten feedstock in the stationary melting furnace;
heating the solidification crucible to a temperature above the melting point of the feedstock;
flowing the molten feedstock through the outlet into the solidification crucible; and
cooling the solidification crucible at a rate sufficient to directionally solidify the molten feedstock, thereby producing an ingot.

2. The method of claim 1, wherein the chamber has an upper portion wherein the inwardly facing surface of the chamber extends substantially vertically and has a lower portion wherein the inwardly facing surface of the chamber is generally conical and tapers downwardly toward the outlet.

3. The method of claim 1, wherein the solidification module further comprises a heat sink positioned below the solidification crucible to receive heat from the crucible and the molten feedstock.

4. The method of claim 1, wherein:
the feedstock consists essentially of silicon; and
an ingot of multi-crystalline silicon is produced.

5. The method of claim 1, wherein introducing the feedstock into the stationary melting furnace further comprises:
introducing a first batch of feedstock into the stationary melting furnace; and
subsequently introducing two or more sequential batches of feedstock into the stationary melting furnace, wherein one or more of the sequential batches has a mass greater than the first batch.

6. The method of claim 1, wherein introducing feedstock into the stationary melting furnace further comprises:
introducing a batch of feedstock having a desired mass into a feedstock container; and
transferring feedstock from the feedstock container into the stationary melting furnace in a continuous manner, wherein the feedstock is transferred into the stationary melting furnace at a rate greater than a rate of molten feedstock flowing through the outlet.

7. The method of claim 1, further comprising:
separating the solidification module from the stationary melting furnace;
providing at least one additional solidification module comprising an additional solidification crucible;
positioning the at least one additional solidification module to receive molten feedstock from the stationary melting furnace;
preheating the additional solidification crucible to a temperature above the melting point of the feedstock;
flowing molten feedstock through the outlet into the additional solidification crucible; and
cooling the additional solidification crucible to directionally solidify the molten feedstock, thereby producing a silicon ingot.

8. The method of claim 1, further comprising:
maintaining the stationary melting furnace at a temperature below the melting point of the feedstock in the vicinity of the outlet while the feedstock is heated to produce molten feedstock such that solidified feedstock forms a plug within the outlet; and
subsequently increasing the temperature in the vicinity of the outlet above the melting point of the feedstock to melt the plug and initiate flow of molten feedstock through the outlet into the solidification crucible.

9. The method of claim 8, further comprising maintaining the chamber at a negative pressure while melting the feedstock.

10. The method of claim 8, wherein the stationary melting furnace further comprises a first valve assembly and the solidification module further comprises a second valve assembly, the method further comprising:
positioning the solidification module to receive molten feedstock from the stationary melting furnace by detachably coupling the first valve assembly to the second valve assembly:
closing the first and second valve assemblies while melting the feedstock; and
subsequently opening the first and second valve assemblies before the plug melts.

11. The method of claim 1, wherein introducing feedstock comprises introducing the feedstock from a feedstock production process.

12. The method of claim 11, wherein the feedstock is produced in a chemical reactor.

13. A system for melting feedstock and casting an ingot, the system comprising:
(a) a feedstock source;
(b) a stationary melting furnace positioned to receive feedstock, the stationary melting furnace comprising
a vessel that defines a chamber, the vessel having a feed port positioned to pass feedstock into the chamber and having an outlet,
a furnace insulation layer,
one or more furnace heating elements, and
an outer furnace shell;
(c) a docking assembly comprising a passageway positioned to receive molten feedstock from the outlet and to control the flow of molten feedstock from the chamber; and
(d) a solidification module capable of being detachably coupled to the stationary melting furnace to receive the flow of molten feedstock, the solidification module comprising
an outer solidification module shell,
a solidification module insulation layer positioned inwardly of the outer solidification module shell, wherein the solidification module insulation layer defines an inner chamber,
a solidification crucible positioned in the inner chamber, and
a heating element positioned to heat the contents of the solidification crucible,
a crucible support positioned to support the solidification crucible, and
a heat sink positioned to receive heat from contents of the solidification crucible.

14. The system of claim 13, wherein:
the stationary melting furnace further comprises
a gas inlet that is defined by and extends through an upper wall of the outer shell and is in fluid communication with the chamber, and
a vacuum port that is defined by and extends through a wall of the outer shell and is in fluid communication with the chamber;
the vessel has an upper portion wherein the inwardly facing surface of the upper portion extends substantially vertically and has a lower portion wherein the inwardly facing surface of the lower portion is generally conical and tapers downwardly toward the outlet;
the docking assembly further comprises
a first valve assembly coupled to a lower wall of the stationary melting furnace, and
a second valve assembly coupled to an upper wall of the solidification module, wherein the second valve assembly is capable of being removably coupled to the first valve assembly, thereby removably coupling the solidification module to the stationary melting furnace, such that molten feedstock can flow from the chamber to the solidification module via the passageway;
the solidification module shell comprises an upper wall that defines a first aperture;
the solidification module insulation layer comprises an upper wall that defines a second aperture that is positioned below the first aperture; and
the solidification crucible defines a cavity having an upwardly facing opening that is positioned below the first and second apertures at such a location that molten feedstock can flow by gravity from the passageway, through the first and second apertures, and into the cavity.

15. The system of claim 13, further comprising a feed system comprising:
a docking system;
a vibrating feeder or a pneumatic conveyor feeder;
a gravimetric feeder for receiving feedstock form the vibrating feeder or the pneumatic conveyor feeder, the gravimetric feeder comprising an inlet flow control device and an outlet flow control device; and
a vacuum lock hopper for receiving feedstock from the gravimetric feeder, wherein the vacuum lock hopper is operably coupled to a vacuum source, the vacuum lock hopper further comprising an inlet valve, an outlet valve, and a feed pipe extending from the outlet valve.

16. The system of claim 13, further comprising a feed system comprising:
a powder transfer suction tube comprising a first open end, a second open end, a gas flow inlet, and a hose flush inlet;
a first gas inflow line in communication with the gas flow inlet;
a second gas inflow line in communication with the hose flush inlet;
a vacuum lock hopper operably coupled to a source of negative pressure, the vacuum lock hopper further comprising an inlet valve, an outlet valve, and a feed pipe extending from the outlet valve; and
a vacuum transfer hose in fluid communication with the second open end of the powder transfer suction tube and the inlet valve of the vacuum lock hopper;

17. The system of claim 13, further comprising an outlet heating element operable to maintain the vicinity of the outlet at a temperature independent of a temperature in the furnace chamber.

18. The system of claim 13, wherein:
the solidification crucible has an upper rim; and
the system further comprises a flow diffuser comprising a flow guide and a mounting assembly configured to support the flow guide on the upper rim of the solidification crucible.

19. The system of claim 13, wherein the feedstock comprises silicon and the vessel, the solidification crucible, or both are constructed of quartz or fused silica.

20. The system of claim 13, wherein the feedstock source is a feedstock container or a chemical reactor.
